(19) United States
(12) Patent Application Publication
(10) Pub. No.: US 2006/0124328 A1
(43) Pub. Date: Jun. 15, 2006

(54) Loader for agricultural tractors

(76) Inventor: Staffan Schager, Stockholm (SE)

Correspondence Address: ALFRED J MANGELS, 4729 CORNELL ROAD, CINCINNATI, OH, 452412433, US

(21) Appl. No.: 10/540,970

(22) PCT Filed: Nov. 14, 2002
(86) PCT No.: PCT/SE03/01772

§ 371 Date: Dec. 2, 2005

(30) Foreign Application Priority Data
Dec. 30, 2002 (SE) 02038941

(51) Int. Cl. A01B 59/04

(52) U.S. Cl. 172/810

(57) ABSTRACT

A loader for agricultural tractors having standard, hydraulically maneuverable, parallel lifting arms. The lifting arms are pivotally mounted at the rear of the tractor, which also includes a centrally positioned attachment member between the lifting arms. The loader includes two parallel loader arms for attachment to respective lifting arms and that also extend rearwardly from the lifting arms. A hydraulically-operated, axially extensible center rod extends outwardly from the tractor center attachment member, substantially parallel to the lifting arms. The outer ends of the loader arms and the outer end of the center rod are connected to a suitable working implement or appliance that is supported for tilting and upward and downward movement relative to the tractor.

### BACKGROUND OF THE INVENTION

1. Field of the Invention

The present invention relates to a loader for agricultural tractors.

2. Description of the Related Art

One problem experienced on smaller farms resides in the need of a so-called front loader, i.e., a tractor-like vehicle that includes two externally mounted hydraulically maneuverable lifting arms for supporting a bucket, or lifting forks, or some other implement or appliance at their free ends.

The problem arises because the purchasing cost of such front loaders is too high in relation to the use of the vehicle, meaning that small farms are often forced to manage without the use of a front loader.

Agricultural tractors do not come equipped with externally mounted lifting arms and it is expensive to modify such a tractor by fitting it with such arms.

This problem is solved by the present invention, which provides a solution which enables a conventional tractor to be readily and cheaply fitted with a working implement or appliance so that the tractor can fulfil the function of a front loader.

### SUMMARY OF THE INVENTION

The present invention thus relates to a loader for agricultural tractors equipped with standard hydraulically maneuverable, parallel lifting arms. The lifting arms are pivotally mounted in the rear part of the tractor and include a center attachment on the tractor between the lifting arms. The loader includes two parallel arms which are attached to respective lifting arms and to extend rearwardly generally in the longitudinal direction of said lifting arms. A center rod that can be extended hydraulically during operation extends outwardly from said center attachment parallel with the lifting arms. The respective arms and the outer end of the center rod are adapted for connection to a working implement or appliance.

### BRIEF DESCRIPTION OF THE DRAWINGS

The invention will now be described in more detail, partially with reference to an exemplifying embodiment thereof illustrated in the accompanying drawings, in which:

FIG. 1 is a perspective view of a tractor seen obliquely from the rear and including features according to the present invention;

FIG. 2 is a perspective view of an inventive loader arrangement;

FIGS. 3 and 4 are respective views of the FIG. 2 loader arrangement in different positions;

FIG. 5 illustrates different loader lifting heights; and

FIG. 6 illustrates different loader attachment points.

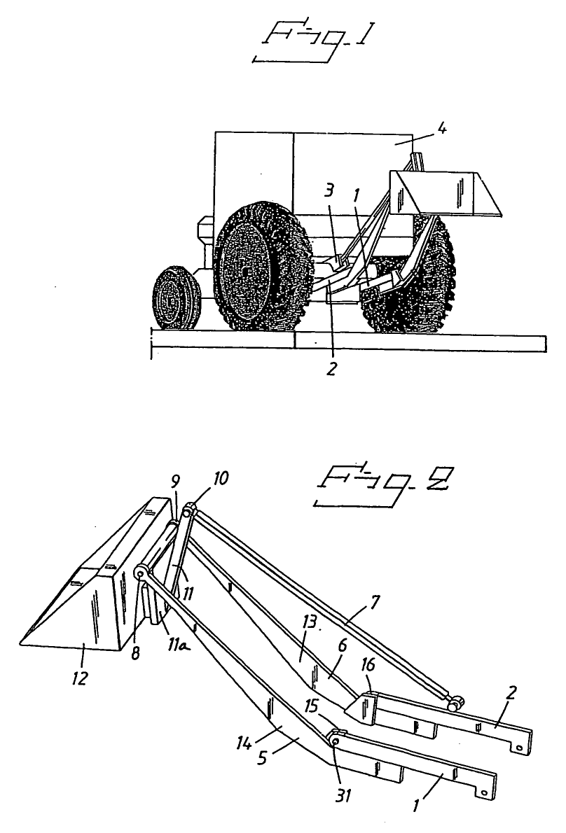

### DESCRIPTION OF THE PREFERRED EMBODIMENTS

Both small and larger conventional tractors are equipped with standardized, hydraulically maneuverable and parallel lifting arms attached to the rear part of the tractor. The arms are intended to support different working implements, such as plows, harrows, etc., and are able to raise and lower the same as required.

The invention relates to a loader for tractors equipped with such standardized, hydraulically maneuverable parallel lifting arms 1, 2 pivotally attached to the rear part of the tractor and provided with a center attachment member 3 on the tractor 4 between said lifting arms 1, 2.

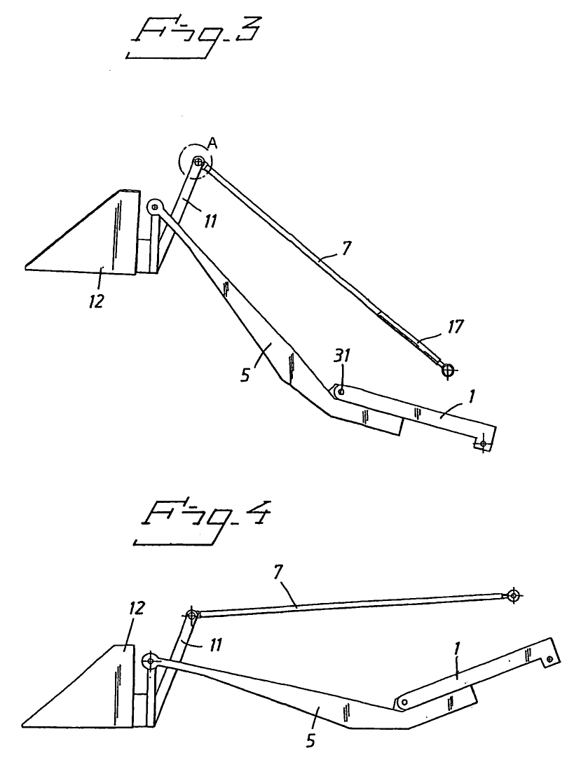

As will be apparent from FIG. 3, the inventive loader includes two parallel arms 5, 6 which are intended to be fastened to respective lifting arms 1, 2 so as to extend rearwardly out from the tractor generally, in the longitudinal direction of the lifting arms 1, 2.

A center rod 7, which can be extended hydraulically during operation, extends outwards from the center attachment member 3 in the same direction as the arms 5, 6.

Respective arms 5, 6 and the outer end of the center rod 7 are intended for connection to a working implement 12.

According to one preferred embodiment, outer ends 8, 9 of respective arms 5, 6 and the outer end 10 of the center rod 7 are intended for connection to an attachment member 11a to which working implement 12 is attached. Attachment member 11a includes an attachment arm 11. The ends 8, 9, 10 are pivotally attached to the attachment member 11a, whereas the working implement 12 is fixedly connected thereto.

Alternatively, outer ends 8, 9 of respective arms 5, 6 and the outer end 10 of the center rod 7 can be adapted for direct connection to a working implement.

The loader is made of a suitable steel material.

Although the working implement 12 is shown in the drawings in the form of a bucket or scoop, it will be understood that it may be any implement or appliance whatsoever, such as lifting forks, a lifting bar or rod for lifting cement pipes, a platform, or a snow plow. The present invention is therefore not restricted to any given form of implement. Neither is the invention restricted to any particular attachment design, since the person skilled in the art will be able to adapt the attachment means to the implement concerned.

The arms 5, 6 and the working implement 12 are lifted in response to lifting of the lifting arms 1, 2. The implement can be tilted, i.e., swung about a horizontal axis, by changing the length of the center rod.

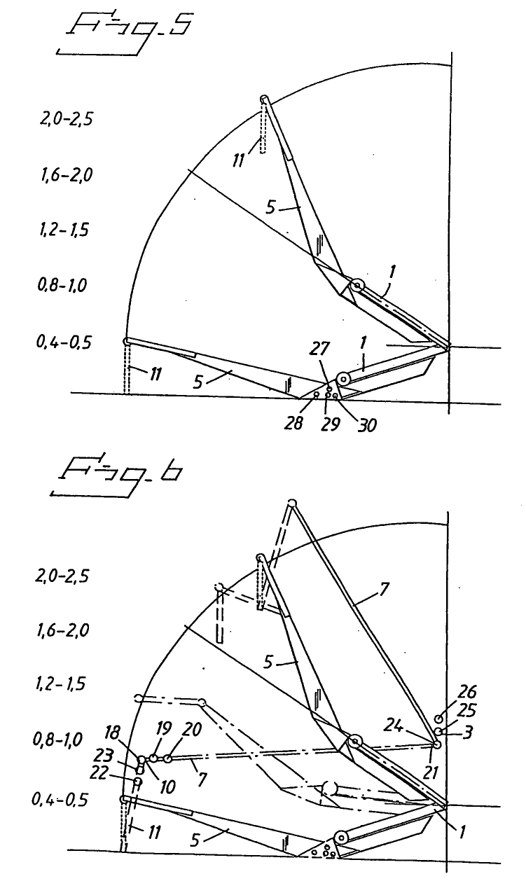

The swing range of the standardized lifting arms 1, 2 is such that the arms will not define a sufficiently small angle with the vertical plane when raised to a maximum; see FIG. 5, which shows the lifting arm 1 when swung up to its upper end position.

The arms 5, 6 are therefore inclined upwards in a region 13, 14 outwardly of and close to the free ends 15, 16 of the lifting arms 1, 2. This achieves a high working implement lifting height while also allowing the working implement to be lowered down onto the ground.

FIG. 5 illustrates swinging of the loader in a vertical plane. In this case, the arms 5, 6 are designed for a lifting height of roughly 2.5 meters, which is sufficient for the majority of tasks on a typical farm. The lifting height can be increased by making the arms 5, 6 longer. However, longer arms will reduce the maximum load bearing capacity.

According to one preferred embodiment, the inclination angle of the arms 5, 6 relative to lifting arms 1, 2 is adjustable, therewith enabling the maximum lifting height of the arms to be varied. In one simple embodiment, respective arms 5, 6 are divided and hinged about a joint 27, said arm parts being provided with spaced holes 28-30, as shown in FIG. 5, for co-action with a pin (not shown) so as to hold the arms 5, 6 at the chosen inclination angle.

According to one preferred embodiment there is provided at the outer ends 8, 9 of respective arms a joint that functions to pivotally support an implement attachment member 11a or an implement 12. A joint for pivotal connection to an attachment member 11a at an end of attachment arm 11, or to an implement 12, is provided at the outer end 10 of the center rod 7.

In a preferred embodiment the center rod 7 includes along its length an hydraulic piston-cylinder device which is used to change the length of the center rod, said device being driven by the tractor's hydraulic system.

Preferably, the outer end 10 of the center rod 7 will include a number of spaced attachment points 18-20 (see FIG. 6) for co-action with the attachment member 11a or an implement 12 at mutually different distances from the inner end 21 of center rod 7. The attachment arm 11 may also be provided with different, spaced attachment points 22, 23, for attachment of the outer end of the center rod 7.

The center attachment member 3 on tractor 4 is also preferably provided with a number of spaced attachment points 24-26 for co-action with the inner end 21 of the center rod 7.

The various spaced attachment points 18-20, 22, 23, 24-26 enable the connection points for arms 5, 6 and for center rod 7 to be adapted to suit different implements, according to their geometrical designs.

According to one highly preferred embodiment, respective arms 5, 6 are secured at their inner ends to the standard tractor attachment members in the form of respective lifting arms 1, 2 by means of cotter pins, split pins, or the like 31. It is also preferred that respective arms 5, 6 project to some extent below respective lifting arms 1, 2 and abut against the underside of said lifting arms, as shown in FIG. 3. This means that pins 31 of this embodiment are the sole means required to effect attachment of the arms 5, 6 to the lifting arms 1, 2, therewith enabling the inventive loader to be secured in a very simple manner.

It will be apparent that the present invention provides an easy and inexpensive solution to the problem mentioned in the introduction.

Although the invention has been described above with reference to a number of embodiments thereof, it will be apparent to the person skilled in the art that the structural design of the loader can be varied.

The invention shall not therefore be considered to be limited to the above-described and illustrated embodiments, since modifications can be made within the scope of the following claims.

What is claimed is:

1. A loader for agricultural tractors equipped with hydraulically maneuverable, parallel lifting arms which are pivotally mounted at the rear part of the tractor together with a center attachment member between the lifting arms, said loader comprising: two parallel loader arms including means for attachment of the loader arms to respective tractor-mounted lifting arms to extend rearwardly in a generally longitudinal direction relative to the tractor: a hydraulically extendable center rod including an inner end for connection with the center attachment member and that extends outwardly from the center attachment member substantially parallel with the lifting arms; wherein outer ends of respective loader arms and an outer end of the center rod are adapted for connection to a working implement.

2. A loader according to claim 1, wherein the loader arms are inclined upwards in a region outwardly of and close to an outer end of a respective lifting arm.

3. A loader according to claim 1, wherein respective loader arm outer ends and the outer end of the center rod include attachment means for attachment to a working implement.

4. A loader according to claim 3, wherein the inclination of the loader arms relative to the lifter arms is adjustable.

5. A loader according to claim 3, wherein the connecting means included at the outer ends of respective loader arms is include a pivot adapted to pivotally support the working implement; and wherein at the outer end of the center rod is a pivot joint adapted for pivotal connection to the working implement.

6. A loader according to claim 1, wherein the center rod includes along its length an hydraulic piston-cylinder device which functions to change the length of the center rod.

7. A loader according to claim 1, including spaced attachment points at the outer end of the center rod for co-action with one of an attachment arm and the working implement, wherein the attachment points are spaced at mutually different distances from the inner end of said center rod.

8. A loader according to claim 1, wherein inner ends of respective loader arms are secured to a respective lifting arm by means of one of cotter pins and split pins; and wherein respective loader arms extend below respective lifting arms for and abut an underside of a respective lifting arm.
